(19) United States
(12) Patent Application Publication
(10) Pub. No.: US 2021/0321496 A1
(43) Pub. Date: Oct. 14, 2021

(54) FOOD PACKAGING ARTICLES INCLUDING SUBSTRATES WITH METAL NANOPARTICLES

(71) Applicant: Folia Water, Inc., New York, NY (US)

(72) Inventor: Theresa DANKOVICH, Medford, MA (US)

(73) Assignee: Folia Water, Inc., New York, NY (US)

(21) Appl. No.: 17/267,294

(22) PCT Filed: Aug. 30, 2019
(86) PCT No.: PCT/US2019/049097

§ 371 Date: Feb. 9, 2021

Related U.S. Application Data
(60) Provisional application No. 62/724,744, filed on Aug. 30, 2018.

(51) Int. Cl. H05B 6/64; B32B 1/02; B32B 3/10; B32B 15/12; B65D 81/34; D21J 1/08; D21J 3/10

(52) U.S. Cl. CPC H05B 6/6491; B65D 2581/3468; B32B 3/10; B32B 15/12; B65D 81/3453; D21J 1/08; D21J 3/10; B32B 2250/02; B32B 2307/202; B32B 2439/70; B65D 2581/3494; B65D 2581/3472; B65D 2581/3477; B65D 2581/3479; B32B 1/02

(57) ABSTRACT

An embodiment of the present disclosure a food package article with metal nanoparticles. The metal nanoparticles may absorb microwave radiation and converts microwave radiation into heat.

### CROSS-REFERENCE TO RELATED APPLICATIONS

This disclosure claims priority and the benefit of U.S. Provisional Application No. 62/724,744, filed on Aug. 30, 2018, entitled “Food Packaging Articles Including Substrates with Metal Nanoparticles,” the entire disclosure of which is incorporated by reference into the present application. The present application is also a continuation-in-part of U.S. application Ser. No. 16/069,595, filed Jul. 12, 2018, entitled “Substrates With Metal Nanoparticles, Related Articles, And A Continuous Process For Making Same,” which is a national stage entry under 35 U.S.C. 371 of PCT Application No. PCT/US2017/013608, filed Jan. 14, 2017, which the claims the benefit of and priority to U.S. Provisional Application Ser. No. 62/278,748. Filed Jan. 14, 2016, the entire disclosures of which is incorporated by reference into this application.

### TECHNICAL FIELD

The present disclosure relates to a food packaging article formed from a substrate having metal nanoparticles, including methods for related such food packaging articles.

### BACKGROUND

Susceptors are currently added to microwave heating packages for enhancing the browning and/or crisping of the food item. While the typical microwave oven is a suitable energy source for uniform cooking, it is not satisfactory for selective heating effects, such as browning and crisping. In a typical microwave arrangement, the external surface of the cooked material, particularly if desired to be crispy, tends to be soggy and unappetizing in appearance. See e.g. U.S. Pat. No. 4,959,516.

Conventional means to enhance browning through microwave food packaging includes use of a susceptor incorporated into the packaging. A susceptor is a thin layer of microwave energy interactive material. When exposed to microwave energy, the susceptor tends to absorb a portion of the microwave energy and convert it to thermal energy (i.e. heat) through resistive losses. The remaining microwave energy is either reflected by or transmitted through the susceptor. In most cases, the cooked material needs to reach a temperature of at least 350° F. (177° C.) within the first few minutes of heating in order to produce desirable browning and crisping effects.

Susceptors are typically comprised of a susceptor film and a support layer, such as paper or paperboard. The susceptor film may include an aluminum coating, about 500 angstroms in thickness, supported on a polymer film. The susceptor film is typically joined to the support layer using an adhesive or otherwise, to impart dimensional stability to the susceptor film and to protect the aluminum layer from being damaged. See e.g. U.S. Patent Pub. No. 2010/0213192. The adhesion through a polymer film lamination to the paper-based support layer prevents the flow of liquid from the food item as the food item is heated in the microwave. The polymer layer is typically a hydrophobic polymer, such as polyethylene terephthalate. Inhibition of water transport through the susceptor can result in soggy food items and incomplete browning. As a result, conventional susceptor packaging is designed as a sleeve to fit around the food item, but does not completely enclose the food item. The sleeve design results in both a loss of water and heat from the food item during cooking.

### SUMMARY

There is a need to provide food packaging articles and susceptors that enable faster cooking times and better browning and crisping effects. An embodiment of the present disclosure includes a dimensionally stable substrate having a first side and a second side that is opposite the first side. The dimensionally stable substrate also includes a metallic layer disposed directly on the first side and composed of a plurality of metal nanoparticles having a size that ranges from 1 to about 200 nanometers in at least one dimension. The metallic layer has a thickness that it absorbs microwave radiation and converts microwave radiation into heat. The metallic layer does not inhibit the flow of moisture through the dimensionally stable substrate layer.

Another embodiment of the present disclosure includes a microwavable food package, comprising a microwavable article having an internal space for holding at least one food item. The microwavable food package also includes a susceptor within the internal space of the microwavable article and having a) a dimensionally stable substrate having a first side and a second side that is opposite the first side, and b) a metallic layer disposed along the first side. The metallic layer is composed of a plurality of metal nanoparticles having a size that ranges from 1 to about 200 nanometers in at least one dimension. The metallic layer has a thickness that it absorbs microwave radiation and converts microwave radiation into heat. The metallic layer does not inhibit the flow of moisture through the dimensionally stable substrate layer.

Another embodiment of the present disclosure includes a microwavable food package article comprising a three-dimensional molded structure having a homogenous mixture a cellulosic pulp and metal nanoparticles disposed directly on or embedded in the cellulosic pulp. The metal nanoparticles having a size that ranges from 1 to about 200 nanometers in at least one dimension. The metal nanoparticles present in the three-dimensional molded structure in an amount sufficient to absorb microwave radiation and converts microwave radiation into heat.

Another embodiment of the present disclosure includes a method of forming a metallized food package. The method includes forming a slurry including cellulosic fibers. The method also includes adding a metal precursor solution to the slurry, the metal precursor solution having one or more metal salts and a reducing agent. The method also includes depositing the slurry containing the metal precursor solution onto one or more mold forms. The method also includes exposing the slurry containing the metal precursor solution deposited on the one or more mold forms to thermal energy to initiate a reaction of metal ions and slurry, thereby giving rise to metal nanoparticles deposited on or embedded within the cellulosic fibers to form a metallized three-dimensional molded structure. The method also includes removing the metallized three-dimensional molded structure from the one or more mold forms.

Another embodiment of the present disclosure includes a method of forming a metallized food package. The method includes forming a slurry including cellulosic fibers and depositing the slurry onto one or more mold forms. The method includes applying a metal precursor solution to the slurry deposited onto the one or more mold forms. The method also exposing the metal precursor solution to thermal energy, thereby giving rise to metal nanoparticles deposited on or embedded within the cellulosic fibers to form a metallized three-dimensional molded structure. The method also includes removing the metallized three-dimensional molded structure from the one or more mold forms.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is a schematic sectional view of a microwave susceptor according to an embodiment of the present disclosure;

FIG. 2 is a schematic of a processing line used to form the susceptor shown in FIG. 1, according to an embodiment of the present disclosure.

FIG. 3A is a schematic plan view of a microwave susceptor according to another embodiment of the present disclosure;

FIG. 3B is a schematic sectional view of the microwave susceptor shown in FIG. 3A;

FIG. 4 is a schematic sectional view of a microwavable food package article according to an embodiment of the present disclosure;

FIG. 5 is a schematic sectional view of a microwavable food package article according to another embodiment of the present disclosure;

FIG. 6A is a schematic perspective view of a microwavable food package article according to another embodiment of the present disclosure;

FIG. 6B is a schematic sectional view of the microwavable food package article shown in FIG. 6A;

FIG. 7 is a top view of planar blank used for form the microwavable food package article shown in FIGS. 6A and 6B;

FIG. 8 is a schematic top view of a microwavable food package article according to another embodiment of the present disclosure;

FIG. 9 is a schematic view of a microwavable food package shown in FIG. 8;

FIG. 10 is a process flow diagram illustrating a method for forming the microwavable food package article shown in FIGS. 8 and 9; and

FIG. 11 is a process flow diagram illustrating another method for forming the microwavable food package article.

### DETAILED DESCRIPTION OF ILLUSTRATIVE EMBODIMENTS

Embodiments of the present disclosure include food packaging articles and materials including metal nanoparticles used in such food packaging articles. While the typical microwave oven is a suitable energy source for uniform cooking, it is not satisfactory for selective heating effects, such as browning and crisping. As described above, a typical microwave arrangement produces cooked items that may be soggy and unappetizing in appearance. See e.g. U.S. Pat. No. 4,959,516. To allow for water transport through the susceptor during cooking, embodiments of the present disclosure skip the polymer binder (or films that are used) and directly adhere the susceptor to the base substrate layer.

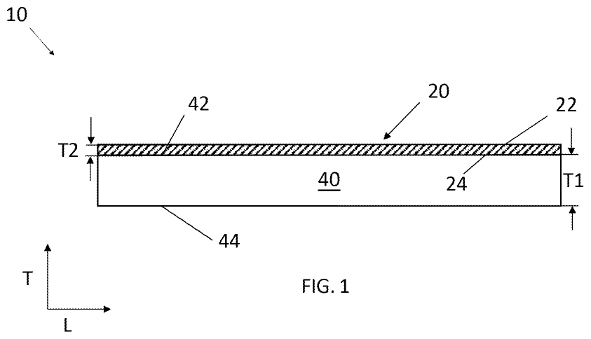

An embodiment of the present disclosure may include a microwave susceptor 10 as shown in FIG. 1. The microwave susceptor 10 has a dimensionally stable substrate layer 40 having a first side 42 and a second side 44 that is opposite the first side 42, and a metallic layer 20 disposed directly on the first side 42. The substrate layer 40 is configured to provide structural support to the susceptor 10 but permit to moisture to pass therethrough. The metallic layer 20 is configured to enable browning of the foot item during use in the microwave while also permitting adequate moisture transport through the susceptor 10, as further explained below. The metallic layer 20 may extend substantially along an entirety of a width and a length L of substrate layer 40 such that there are limited, if any, breaks in continuity of the metallic layer 20 along the first side 42 of the substrate layer. Furthermore, in alternative embodiments, the metallic layer may extend into an entire depth of the substrate layer.

The dimensionally stable substrate layer 40 may include any suitable substrate for food packaging use. In the illustrated embodiment, the substrate layer 40 includes a cellulosic substrate. For example, the cellulosic substrate may include paper or paperboard. In alternative embodiments, the substrate layer 40 may include a non-woven material or a laminate of a cellulosic substrate and a non-woven material. The substrate layer 40 may be embossed, crimped, folded, pressed, molded, formed or otherwise have some variation in structure or texture. In still other embodiments, the substrate layer 40 is a cellulosic layer. Such a cellulosic layer may comprise one or more layers of material.

Exemplary cellulosic substrates may be formed from cellulosic fibers or cellulosic materials. The cellulosic fibers may be wood pulp, cotton, rayon, or any other cellulosic material, whether naturally derived or synthetic. In one example, the cellulosic fiber is wood pulp used to form paper or paperboard. The cellulosic substrates may be a single-ply or a multi-ply structure. Exemplary papers include, but are not limited to tissue paper, filter paper, cardstock, corrugated cardboard, recycled paper, and/or virgin paper. The paper may be creped or smooth in texture.

Exemplary nonwoven materials may be made from non-cellulosic fibers, cellulosic fibers, or a blend of cellulosic and non-cellulosic fibers. For example, the substrate layer 40 may include polymer fibers. Exemplary polymer fibers include, but are not limited to, polyethylene terephthalate, polyamide, polypropylene, polyethylene, and poly lactic acid. Thus, the nonwoven materials may include spundbond, meltblown, spunbond-meltblown laminates, spun-laced, drylaid, or wetlaid nonwovens, or laminated layers thereof, or a combination of any of these materials. In summary, a wide range of substrate layers can be used.

The substrate layer 40 is configured to enable transport of moisture through the susceptor 10. To achieve a desirable level of moisture transport, the substrate layer 40 may have a weight, thickness, porosity and water absorptivity that enables efficient moisture transport. In general, the substrate layer 40 may have a range of weights suitable for food packing articles. In one example, the substrate layer 40 has a basis weight between 30 grams per square meter (gsm) to about 400 gsm, measured according to TAPPI Method T 410 “Grammage of Paper and Paperboard (Weight Per unit area),” which is incorporated by reference into the present disclosure. TAPPI method T 410 is that which was in effect at the earliest filing of the present application.

The substrate layer 40 has a thickness T1 selected to enable moisture transport. As illustrated, the thickness T1 extends from the first side 42 to the second side 44. The thickness T1 is substantially perpendicular to a planar surface of the substrate layer 40. In one example, the substrate layer has a thickness T1 between about 5 nanometers to 500 microns, measured according to TAPPI method 411 Thickness (caliper of paper, paperboard, and combined board), which is incorporated by reference into the present disclosure. TAPPI method 411 stated is that which was in effect at the earliest filing of the present application.

The porosity of the substrate layer 40 is also selected to enable moisture transport. For instance, the substrate layer 40 has a porosity, such as Gurley porosity, that may range from 1 secs to 30 secs per 100 mL, measured according to TAPPI method T 460 om-02 “Air resistance of paper (Gurley method),” which is incorporated by reference into the present disclosure. TAPPI method T460 stated is that which was in effect at the earliest filing of the present application. It is believed that a lower Gurley porosity measurement in the susceptor 10 corresponds to better browning when used in the microwave. For instance, a more porous structure with lower Gurley values should allow liquid from the food item to migrate away from the food item more effectively, which could result in the food item attaining a higher degree of browning at a faster rate. Thus, the lower the Gurley porosity, the faster the liquid transport through the susceptor 10, and the faster the browning in the microwave. In practice, however, the amount of moisture transferred through the susceptor 10 may depend upon the moisture content of the food item to be heated. For instance, some food items will result in a greater loss of water in the heating process and will require greater liquid removal. It is also possible that loss of oil/grease from food items, which also can be absorbed by the susceptor 10, may affect the heating process to some extent. It is believed that the susceptors made in accordance with the present disclosure may operate effectively with variations in the overall thickness and porosity susceptor.

Furthermore, the substrates may have high water absorptivity. The substrate in general is hydrophobic and can rapidly uptake water. For instance, substrate can have a given volume uptake per unit time that is indicative of high absorptivity. It one example, the substrate layers as described herein can absorbing up to about 50 uL between 5 seconds and 20 seconds.

The metallic layer 20 includes a plurality of metal nanoparticles formed in a substrate or directly added to the substrate layer 40. The metal nanoparticles are configured to act as susceptors to rapidly produce localized heating and reflect microwaves into targeted areas of the food items during microwave heating. The phrase “in the substrate” means that metal nanoparticles may found on the surface of the substrate, on the surface of the fibers, within the interstitial spaces formed by the fibrous matrix, and possibly within the fibers themselves. The metal nanoparticles may include at least one of: silver, gold, platinum, palladium, aluminum, iron, zinc, copper, cobalt, nickel, manganese, molybdenum, cadmium, iridium, and a mixture thereof. In one example, the metal nanoparticles include silver. In another example, the metal nanoparticles may include copper.

The metal nanoparticles have a size that ranges from 1 to about 200 nanometers in at least one dimension. It should be appreciated, however, that the metal nanoparticles described herein may be formed in aggregates that can be quite large, e.g. in the hundreds of nanometers. In one example, the size of the aggregate nanoparticles could be more than 200 nm. However, the size of discrete metal nanoparticles should be between about 1 nm to about 200 nm in diameter. In a preferred example, the size should be between about 1 nm to about 100 nm. In one example, the size of the nanoparticles is between about 1 nm to about 150 nanometers. In another example, the size of the nanoparticles is between about 1 nm to about 100 nanometers. In yet another example, the size of the nanoparticles is between about 1 nm to about 50 nanometers. It should be appreciated that methods described herein may produce a range of nanoparticle sizes, depending on processing conditions, line speeds, etc. The particle sizes may have any number of types of particle size distributions. Thus, there may be range of sizes on nanoparticles in the substrate. In one example, at least 90% of the observed particle size should be less than about 200 nm. Preferably, 90% of the observed particle size should be less than about 100 nm. The size of a metal nanoparticle as used herein is the size in at least one dimension observed in accordance with known image analysis methods for measuring particle sizes of nanoparticles. As illustrated, a “diameter” is used to described the dimension for ease of illustration. The term “diameter” refers to a diameter of a circle that bounds the observed particle in SEM image of the particle, as is known in the art. Use of the term diameter does not imply the metal nanoparticles are perfectly spherical structures. The mean particle size, which may also be used to refer to the size of the metal nanoparticles, is the average particle size for observed measurements in a given sample or test regimen. The metal nanoparticles can have a range of different shapes, including, but not limited to, rod shaped, triangular, spherical, cubic, nanowires, etc.

The metallic layer 20 has a thickness suitable for use as susceptor. As shown in FIG. 1, the metallic layer 20 has a first side 22 and a second side 24 opposite the first side 22, and a thickness T2 that extends from the first side 22 to the second side 24 along a direction that is substantially perpendicular to a planar surface the layer 40. The thickness T2 of the metallic layer 20 may be selected to absorb microwave radiation and convert microwave radiation into thermal energy to brown the food item (not shown) during use. However, the thickness T2 should not be so thick to cause electric arcing in the microwave. In one example, the thickness of the metallic layer 20 may be between about 5 nanometers to 500 microns. In one example, the thickness T2 of the metallic layer 20 varies. In another example, the thickness T2 of the metallic layer 20 is substantially consistent. As described elsewhere, the metallic layer 40 can be a sub-nanometer to micron layer thickness and only on the side intended to be adjacent to the food item.

Furthermore, the metallic layer 20 does not inhibit the flow of moisture through the dimensionally stable substrate layer 40. In the illustrated embodiment, the metallic layer 20 is shown substantially on the side or surface of the substrate layer 40. In an alternative embodiment, the metallic layer 20 may also reside within the internal structure of the substrate layer 40, e.g. between fibers and within voids. In such an embodiment, however, the metallic layer 20 is disposed toward one side and does not typically penetrate through the thickness T2 of the substrate layer 40.

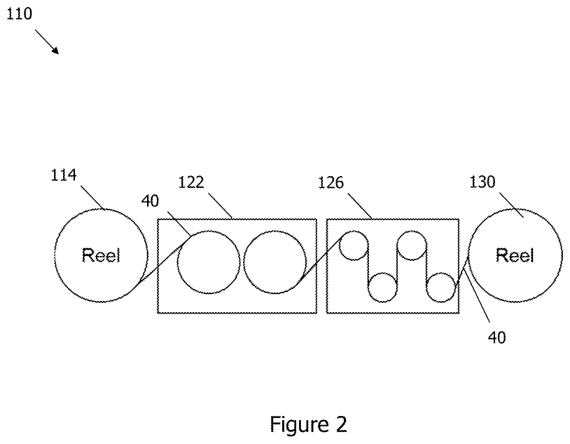

The metallic layer 20 can be applied to the substrate layer 40 via synthesis of a metal salt and a reducing agent on the substrate layer 40. More specifically, an aqueous solution of nanoparticle precursors that includes a metal salt and a reducing agent may be deposited onto the surface of the substrate layer 40 with an application unit 122, as shown in FIG. 2. In such an example, the metal nanoparticles are formed directly on the surface of the substrate layer 40, similar to the surface deposition methods disclosed in PCT Publication No. WO2017124057, the entire disclosure of which is incorporated by reference into the present application for all purposes.

As discussed above, the aqueous solution includes nanoparticle precursors and reducing agent. The nanoparticle precursors may be in form of metal salts that include, but are not limited to silver, gold, platinum, palladium, aluminum, iron, zinc, copper, cobalt, nickel, manganese, molybdenum, cadmium, iridium, and a mixtures thereof. In one example, the metal salt include silver. Typical silver salts include, but are not limited to silver nitrate, silver acetate, silver oxide, silver sulfate, silver hexafluorophosphate, silver tetrafluoroborate, silver perchlorate, silver carbonate, silver chloride, or silver trifluoromethanesulfonate. In the illustrated embodiment, the molar concentration of such a silver salt may range between 0.05 mM to 1000 mM. In other examples, copper salts may be used when the intended nanoparticles includes copper. The recommended range for metallic nanoparticle precursors, such as silver nitrate or other aqueous silver salt or aqueous copper salts, may be between 1 ppm and 10,000 ppm.

Several different reducing agents for metal salts may be used in the process to manufacture the substrate layer 40. Suitable reducing agents, include, but are not limited to, aldehydes and aldehyde forming chemicals. In one example, the reducing agent may be a sugar. The sugar can be a monosaccharide, disaccharide, trisaccharide, and/or a polysaccharide or some mixture thereof, including mixtures of any of the foregoing with other additives. In one example, a reducing sugar includes, but is not limited to, glucose, fructose, galactose, mannose, lactose, maltose, ribose, sorbose, and mixtures, including, but not limited to, corn syrups, glucose syrups, high fructose corn syrup, maltose syrup, and a mixtures thereof. Aldehyde forming chemicals may be used. Exemplary aldehydes and aldehyde forming chemicals may include, but are not limited to, acetaldehyde, glyceraldehyde, as well as non-reducing sugars, such as sucrose, ascorbic acid, alcohol, or mixtures thereof. The reducing agent may be other compounds, such as sodium borohydride, for use on in a two-stage process. Other aldehydes and aldehyde forming chemicals and other sugar derivatives may be use together or singly to reduce the metal ions and form the nanoparticles in the substrate. In addition, any chemical that initiates Tollen's reagent, ammoniacal silver, to form a silver coating would be appropriate.

The aqueous solution may include additional agents. The additional agents may include fillers, binders, pigments, sizing agents, wet strength agents, and other common paper making additives. The additional agents may also be added to the solution to adjust certain properties of the resulting substrate. A person of ordinary skill would appreciate what additional agents may be used in addition to the nanoparticle precursors described above. Exemplary aqueous solutions described herein may include 1 part metal salt to between 20-120 parts of a reducing agent. Such ratios may be suitable for single step application of the aqueous solution to the substrate layer 40. In an example, the aqueous solution may have 1 part silver metal salt to 20 to 120 parts of a sugar, e.g. fructose, glucose, mixtures of glucose and/or fructose or other sugars. In other examples, such as when the precursors are separated into two separate phases during application, the ratio of metal salt to reducing agent may change. An exemplary two-phase solution may have 1 part metal salt to 5 or more parts of a reducing agent, such as, for example, sodium borohydride.

Nanoparticle formation is a reduction process where the reducing agent is present in excess (10× to 1000×) and catalyzed by the heat from the dryer section during the coating manufacturing process. Not all of the reducing sugars are oxidized during the nanoparticle formation, and some unreacted sugar monomers are still present in the nanoparticle coating. During the microwave heating of this susceptor, the reducing sugars will be heated by the combination of microwave heating and localized heat from the metal nanoparticles and start to form caramel pigments through free radical mediated side reactions of the glucose, which will undergo complex caramelization reactions at temperatures greater than 320° F. (160° C.). If the susceptor is in direct contact with the food item, the caramels could be transferred to the surface of the food item for additional flavor and textural features. Sugars are regularly utilized in the food industry to provide crunchy and crisp textures (e.g. hard candies, sugar coating on baked goods, candied nuts), where the crispness would be enhanced by the localized heating effects from the metal nanoparticle susceptors. Similarly, the food surface may have a sugar coating on it and can caramelize in a similar fashion. Microwave heating has previously been shown to produce caramel pigments from glucose saturation of paper substrates in Dankovich, 2014. Additionally, immediately following microwave heating of paper substrates with high glucose levels (0.5 M or higher), the paper sheets were very brittle and crisp due to the loss of water and subsequent caramelization during the microwave heating process. (See e.g. Dankovich, T. A. 2014. Microwave-assisted incorporation of silver nanoparticles in paper for point-of-use water purification. ES Nano 1(4), 367.) Sugars also can create a pleasant fragrance as caramelization process occurs in microwave heating.

Referring to FIG. 2, a processing line 110 used for forming a metallic layer 20 onto the substrate layer 40 is illustrated. The processing line 110 illustrated in FIG. 2 is a reel-to-reel processing line. The processing line 110 includes an unwinding reel 114 holding a substrate layer 40, an application unit 122, a dryer section 126, and a take-up reel 130. In FIG. 2, the processing line 110 unwinds a roll of the substrate layer 40 from the reel 114 and guides the substrate layer 20 to application unit 122. The application unit 122 applies the aqueous solution containing the metal salt and the reducing agent to the substrate layer 40. Next, the dryer section 126 dries the substrate layer 40, which also initiates synthesis of the metal nanoparticles on the substrate layer 40. The formed substrate is wound into roll form via the reel 130. In one example, the metal concentration may be between 0.05% up to about 2.0% of the article. In another example, the metal concentration may be between 0.05% to about 1.0% by weight of the article. Furthermore, the solids pickup from the application unit can range from 5% to about 30%. In addition, the solids content at the application unit can be between 10-60%, with the majority comprising the reducing agent(s). In one example, the solids content can be between about 40% to 60%. In another example, the solids content can be between about 50% to 60%.

The application unit 122 applies the aqueous solution described above of nanoparticle precursors, including the metal salt and a reducing agent, to the moving substrate layer 40. The application unit 122 is located adjacent dryer section 126. Thus, the substrate layer 40 is substantially dry before the solution is applied to the substrate layer 40 in the application unit 122. As shown, the application unit 122 may be a size press as is known in the paper forming arts. The application unit may apply a coating to the surface of the substrate layer 40 by maintaining a shallow pond of the aqueous solution at the nip between two rolls, passing the substrate layer 40 vertically downward through the nip and allowing the substrate layer 40 to absorb the aqueous solution. The size press may use a tray or Dixon coater to contact substrate layer 40 with the aqueous solution. One of skill in the art will recognize that there are several types of application units and methods for applying an aqueous solution to the substrate layer 40. For instance, application unit 122 may include, but is not limited to, spray systems, pond-style, air-knife, metering, blade-coater, slot die, grauvere, meyer rod, and other coating applicators. Furthermore, the application unit 122 may be orientated in any direction, including vertical, horizontal, or inclined arrangements.

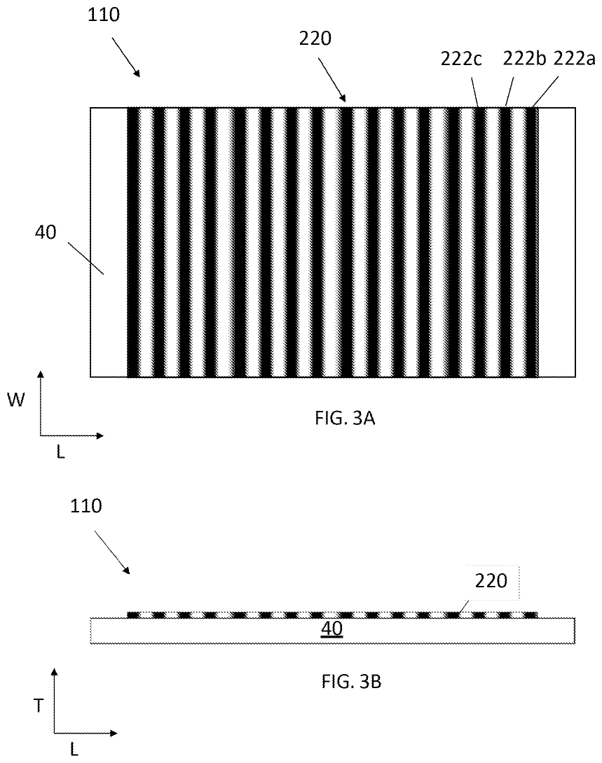

FIGS. 3A and 3B illustrate an alternative embodiment a susceptor 110 used in food packing articles. More specifically, FIGS. 3A and 3B illustrate patterned application of a metallic layer 220 to the substrate layer 40 to define the susceptor 110. The susceptor 110 shown in FIGS. 3A and 3B may include a similar substrate layer 40 to that shown in FIG. 1. Thus, the same reference numbers are used to identify features that are common between the susceptor 10 shown in FIG. 1 and the susceptor 110 shown in FIGS. 3A and 3B. However, in accordance with the illustrated alternative embodiment, the patterned metallic layer 220 is applied to the substrate layer 40 in a pattern element that includes one or more discontinuities along a length L and a width W direction of the susceptor 110. The metallic layer 220 can be deposited throughout the interior of the substrate layer 40 and along the surface of the substrate layer 40 in a specified patterned. Such a patterned deposition can be advantageous to applying targeted heating effects in the center of a food item.

In some embodiments, the metallic layer 220 may be deposited as a patterned element in one or more discrete shapes. In the illustrated embodiment in FIGS. 3A and 3B, the pattern element is a plurality of lines 222a, 222b 222c. As shown, the lines 222a-222c extend along a width W of the susceptor. However, the lines can extend along any particular direction, such as the length L or angled with respect to the length L and the width W. In such an example, the series of lines can generate grill lines on the food item when cooked. Other examples include a susceptor patterned arrangement where the metallic particles are placed on the paper packaging as printed letters, which when heated would produce localized hot spots to cause the browning or grilling to appear as a person's name on the food item, such as a breakfast sandwich “branded” by a particular manufacturer. Alternatively, outlines of logos, graphics, or other graphic elements could be produced as “browned or grilled” features on food items in a similar fashion. Accordingly, the metallic layer 220 may define a pattern element within the susceptor. In one example, the pattern element is a series of parallel lines. In another example, the pattern element includes one or more alphanumeric characters. Furthermore, the pattern element may include one or more two-dimensional shapes that have at least one of a curvilinear component and a linear component. For instance, the pattern element includes a shape that substantially resembles a regular polygon. In yet another example, the pattern element is one or more logos. Furthermore, to assist in the targeted heating process, the thickness of deposited metal susceptor coating, in addition to the patterning, also can be varied to heat specific regions of the food item. Thus, the thickness of the metallic layer 220 within each pattern element can vary as needed.

It should be appreciated that the metallic layer 220 can be applied via any number of mechanisms. In one example, the metallic layer 220 can be applied via flexographic printing. In such an example, pattern application is accomplished by forming a flexographic relief plate with raised elements in the pattern desired to be placed on the susceptor 110. The “ink” applied to the flexographic plate is the metal nanoparticle precursor solution, where the viscosity of the solution is adjusted to be similar to flexographic inks. Following the metal nanoparticle precursor application, the process of forming a patterned layer of metal nanoparticles would occur through a dryer section post-application. Other methods can be used as well. For example, the metallic layer 220 can be applied with a slot-die machine. In another example, the metallic layer 220 can be applied with a gravure printing machine. In another example, the metallic layer 220 can be applied with an offset machine.

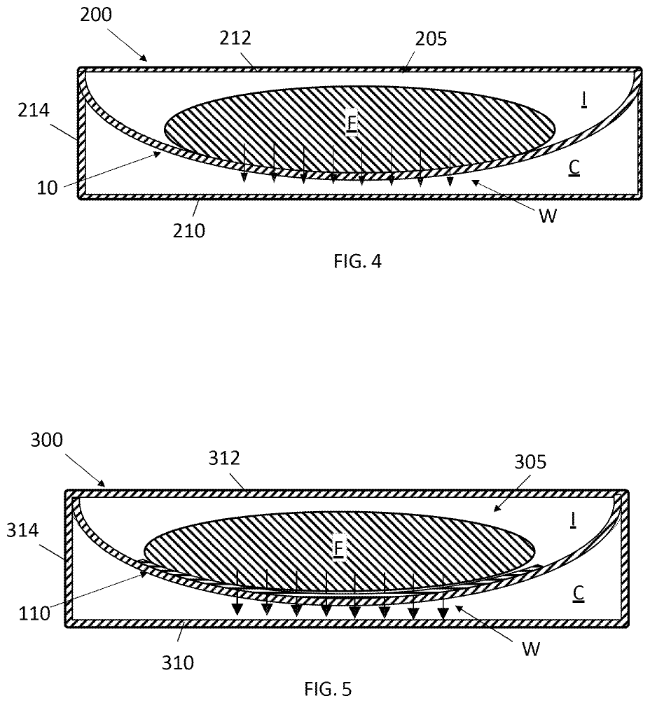

The susceptors 10 and 110 described above may be used in a number of food packaging configurations. One embodiment of the present disclosure includes food packaging article 200 designed to help facilitate transport of moisture away from the food item F during use, as shown in FIG. 4. The illustrated food packaging article 200 includes a microwavable housing 205 for enclosing at least one food item F. The microwavable housing 205 has a bottom 210, a top 212 spaced from the bottom 210, sides 214 that extend between the bottom 201 and the top 212, and an internal space I defined by the bottom, top and sides. The susceptor 10 is joined to the microwavable housing 205 in the internal space I and suspended above the bottom 210 to form an upper space and a lower space or cavity C. The susceptor 10 is as described above and includes a dimensionally stable substrate 40 and the metallic layer 20 is disposed along the first side and is composed of a plurality of metal nanoparticles. Again, the metallic layer 20 is of a thickness that it absorbs microwave radiation and converts microwave radiation into thermal energy. However, the metallic layer 20 does not inhibit the flow of moisture W through the dimensionally stable substrate layer 20. In use, the substrate layer 40 may be formed into an article that is cut to a size. For instance, the articles may be a cut paper having a length of 2-30 cm and a width that is 2-30 cm, wherein the width is perpendicular to the length. The cut article can have any shape suitable for its intended use and may not be rectilinear. As can be seen in FIG. 4, transported moisture W is transferred from and kept away from the food item F. As illustrated, the article is designed so that susceptor 10 is suspended off the bottom of the food packaging article 200. The suspended susceptor 10 creates a void space C in which the transported moisture W drains.

FIG. 5 is another embodiment of a microwave food packaging article 300 using a susceptor 110 with a patterned arrangement. The susceptor 110 used here has a patterned arrangement of the metallic layer 20 directly adjacent to the food item F for targeted heating effect. The article 300 shown in FIG. 5 is otherwise substantially similar to the article 200 shown in FIG. 4 and the same reference numbers are used to identify common features of the two embodiments. The illustrated food article 300 includes a microwavable housing 305 for enclosing at least one food item F. The microwavable housing 305 has a bottom 310, a top 312 spaced from the bottom 310, sides 314 that extend between the bottom 310 and the top 312, and an internal space I defined by the bottom, top and sides. The susceptor 10 is joined to the microwavable housing 305 in the internal space I and suspended above the bottom 310 to form an upper space and a lower space or cavity C.

The susceptor 110 is joined to the microwavable housing in the internal space and suspended above the bottom to form an upper space and a lower space or cavity C. The susceptor 110 is as described above and includes a dimensionally stable substrate layer 40 having a first side and a second side that is opposite the first side. The metallic layer 20 is disposed along the first side and is composed of a plurality of metal nanoparticles. Again, the metallic layer 20 is of a thickness that it absorbs microwave radiation and converts microwave radiation into heat. However, the metallic layer 20 does not inhibit the flow of moisture W through the dimensionally stable substrate layer 40. As can be seen in FIG. 5, transported moisture W is transferred from and kept away from the food item F. As illustrated, the article is designed so that susceptor 110 is suspended off the bottom of the food packaging article 200. The suspended susceptor creates a void space C in which the transported moisture W drains.

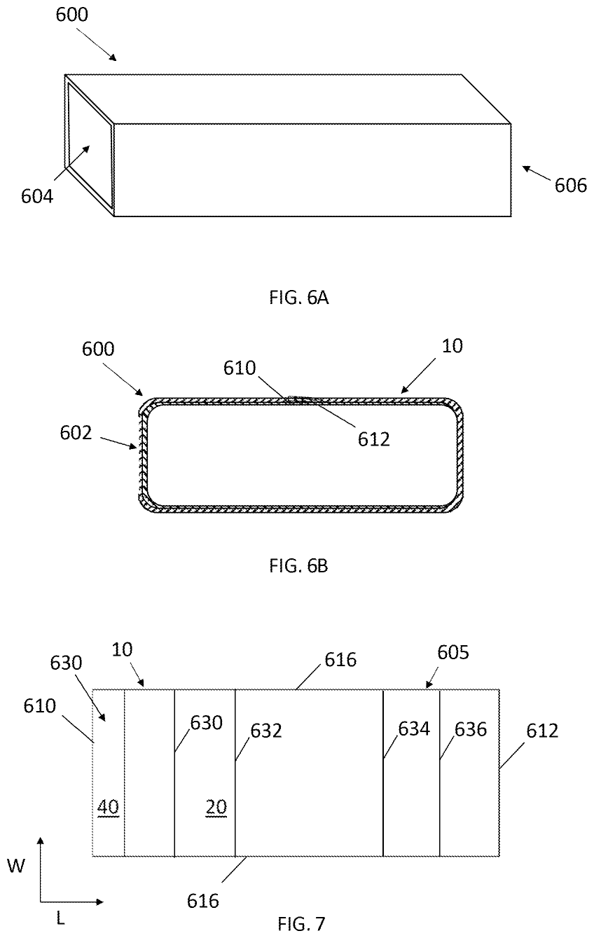

Embodiments of the present disclosure include alternative forms of a packaging article. For instance, as shown in FIGS. 6A through 7, the microwave susceptor may be in the form of a sleeve 600 formed from a planar blank 605. The sleeve 600 may include wall 602 with a first open end 604 and a second open end 606 opposite of the first open end 604. The sleeve is formed from a planar bank 605 as shown in FIG. 7. The planar blank 605 is a cut or formed substrate layer 40 having a first end 610, a second end 612 opposite the first end 612 along a length L, a first side edge 616, and a second side edge 618 opposite the first side edge 616 along a width W. The first side edge 616 and the second edge 618 each extend from the first end 610 to the second end 612 such that generally rectilinear blank is formed. The metallic layer 420 extends from the first side edge to the second side edge along the width W. However, the metallic layer extends along a portion of the substrate layer 20 along the length L to form overlapping surface portion 630. The overlapping surface portion 630 may carry adhesive or some other bonding agent that secures the blank in a sleeve form as shown in FIG. 6B. The blank 605 may multiple fold lines 630, 632, 634, 636, which facilitate formation of the sleeve 605. As shown, the sleeve 600 itself is formed to have two open ends opposite each other. In alternative embodiments, the microwave susceptor is in the form of a closed sleeve with gusseted ends. In yet another example, the microwave susceptor is in the form of a planar disc. In yet another example, the microwave susceptor is disposed along a sidewall of a bag food article. In still another example, the microwave susceptor is in the form of a patch laminated tray.

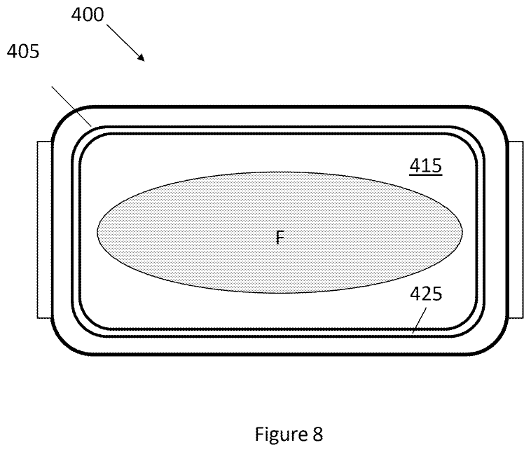

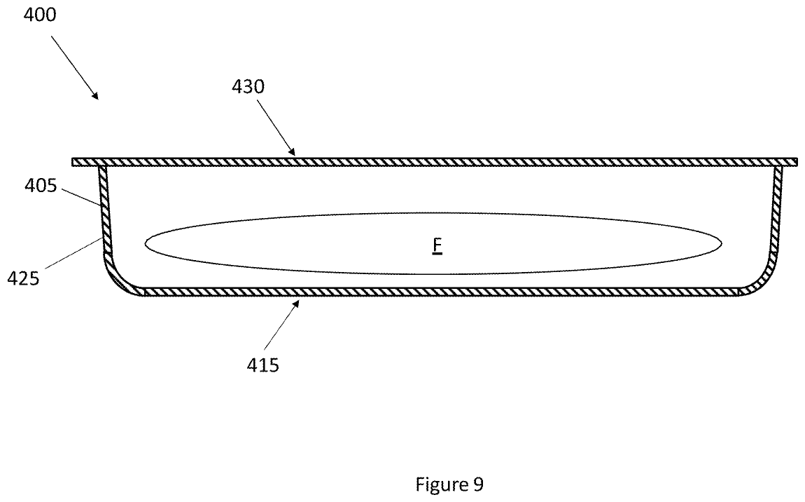

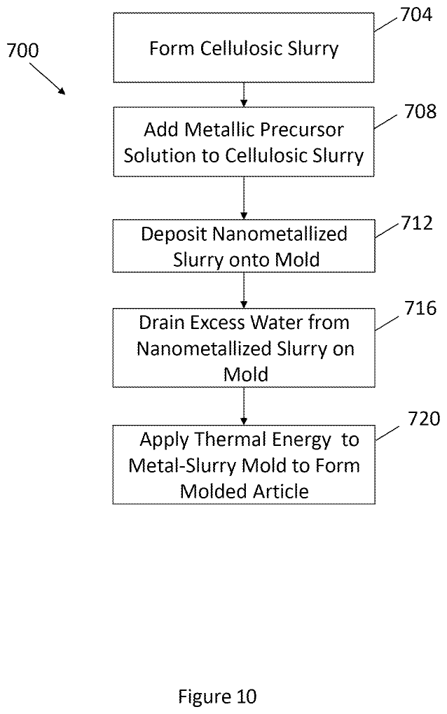

In another embodiment of the present disclosure, a food packaging article 400 includes a housing and susceptor 410 formed as a molded pulp structure comprising metal nanoparticles. FIG. 8 and FIG. 9 illustrate such a microwave food packaging article 400. In the illustrated embodiment, the food packaging article 400 is a molded tray configured to carry at least one food item F. The food packaging article 400 includes an article body 405 having a bottom 415 a top 430, a sidewall 425 that extends upwardly from the bottom 415 to a top 430, and an internal space C defined by the bottom 415 and sidewall 425. The article body 405 itself is formed from cellulosic materials and may include deposited thereon or formed therein metallic nanoparticles to create a molded tray susceptor. In this embodiment, the molded tray is formed from a cellulosic pulp and the metal nanoparticles are formed on or in the pulp during the tray forming manufacturing process 700 as illustrated in FIG. 10.

The metal nanoparticles formed into or on the molded tray 400 have a size that ranges from 1 to about 200 nanometers in at least one dimension. It should be appreciated, however, that the metal nanoparticles described herein may be formed in aggregates that can be quite large, e.g. in the hundreds of nanometers. In one example, the size of the aggregate nanoparticles could be more than 200 nm. However, the size of discrete metal nanoparticles should be between about 1 nm to about 200 nm in diameter. In a preferred example, the size should be between about 1 nm to about 100 nm. In one example, the size of the nanoparticles is between about 1 nm to about 150 nanometers. In another example, the size of the nanoparticles is between about 1 nm to about 100 nanometers. In yet another example, the size of the nanoparticles is between about 1 nm to about 50 nanometers. It should be appreciated that methods described herein may produce a range of nanoparticle sizes, depending on processing conditions, etc. The particle sizes may have any number of types of particle size distributions. Thus, there may be range of sizes on nanoparticles in the substrate. In one example, at least 90% of the observed particle size should be less than about 200 nm. Preferably, 90% of the observed particle size should be less than about 100 nm. The size of a metal nanoparticle as used herein is the size in at least one dimension observed in accordance with known image analysis methods for measuring particle sizes of nanoparticles. The mean particle size, which may also be used to refer to the size of the metal nanoparticles, is the average particle size for observed measurements in a given sample or test regimen. The metal nanoparticles can have a range of different shapes, including, but not limited to, rod shaped, triangular, spherical, cubic, nanowires, etc.

Continuing with FIG. 10, a pulp three-dimensional structure process 700 includes formation 704 a cellulosic slurry. The slurry may be made from cellulosic fibers. The cellulosic fibers may be wood pulp, cotton, rayon, or any other cellulosic material, whether naturally derived or synthetic. For example, the cellulosic fibers may be wood pulp used to form paperboard.

Next, process 700 includes adding 708 a metallic precursor solution to cellulosic slurry. The metallic precursor solution may include a metal salt and a reducing agent. In addition, additional agents, such as binders and the like, may added the slurry during step 708. Such agents may include fillers, binders, pigments, sizing agents, wet strength agents, and other common paper making additives. The additional agents may also be added to the solution to adjust certain properties of the resulting substrate. A person of ordinary skill would appreciate what additional agents may be used in addition to the nanoparticle precursors described above.

Metal salts used in the precursor solution include, but are not limited to, silver, gold, platinum, palladium, aluminum, iron, zinc, copper, cobalt, nickel, manganese, molybdenum, cadmium, iridium, and a mixtures thereof. In one example, the metal salt include silver. Typical silver salts include, but are not limited to silver nitrate, silver acetate, silver oxide, silver sulfate, silver hexafluorophosphate, silver tetrafluoroborate, silver perchlorate, silver carbonate, silver chloride, or silver trifluoromethanesulfonate.

As described above, the precursor solution may also include reducing agents, which may include, but are not limited to, aldehydes and aldehyde forming chemicals. In one example, the reducing agent may be a sugar. The sugar can be a monosaccharide, disaccharide, trisaccharide, and/or a polysaccharide or some mixture thereof, including mixtures of any of the foregoing with other additives. In one example, a reducing sugar includes, but is not limited to, glucose, fructose, galactose, mannose, lactose, maltose, ribose, sorbose, and mixtures, including, but not limited to, corn syrups, glucose syrups, high fructose corn syrup, maltose syrup, and a mixtures thereof. Aldehyde forming chemicals may be used. Exemplary aldehydes and aldehyde forming chemicals may include, but are not limited to, acetaldehyde, glyceraldehyde, as well as non-reducing sugars, such as sucrose, ascorbic acid, alcohol, or mixtures thereof. The reducing agent may be other compounds, such as sodium borohydride, for use on in a two-stage process. Other aldehydes and aldehyde forming chemicals and other sugar derivatives may be use together or singly to reduce the metal ions and form the nanoparticles in the substrate. In addition, any chemical that initiates Tollen's reagent, ammoniacal silver, to form a silver coating would be appropriate. Exemplary precursor solutions for use in the step 708 may include 1 part metal salt to between 20-120 parts of a reducing agent. Such ratios may be suitable for single step application of the aqueous solution to the fibers.

Once the precursor solution is combined with the cellulosic pulp and sufficient mixing has occurred to forma metal precursor-pulp slurry, in step 712, the pulp-metal slurry is deposited onto mold having the shape of the desired food packaging article. The mold may include multiple sets of forms to facilitate increased production rates. In step 716, excess water from the pulp-metal slurry deposited on molds is drained via a vacuum or other means.

In step 720, the drained pulp-metal slurry is fed to heating unit (not shown) where enough thermal energy is applied to remove the remnant moisture from the pulp-metal slurry. Drying the pulp-metal slurry with thermal energy removes moisture but also gives rise to formation metal nanoparticles in the molded tray forms by initiating synthesis of the metal nanoparticles on the pulp. More specifically, for example, drying activates a chemical reaction of the metal salt and the reducing agent, thereby reducing the metal salt to the metal nanoparticles in the substrate. One skilled in the art will readily recognize that the time and temperature profile of drying phase will depend upon such varied factors as the basis weight (grammage) of the substrate, the water retained during application of the solution, the composition of the aqueous solutions, and desired maximum temperature reached during the drying phase. Furthermore, application of thermal energy also gives rise to the visible color change in the pulp-metal tray forms from a first color, such as white, to an orange, yellow, red, purple, blue and/or green paper, indicative of various types of metal nanoparticle formed on the surface of the cellulosic pulp structure.

In step 720, the pulp-metal slurry may be dried until the moisture content of the slurry is between 5-10%. Following step 720, the molded trays may be released from the molds. The molded trays 400 are then combined with any other needed packaging and a food item.

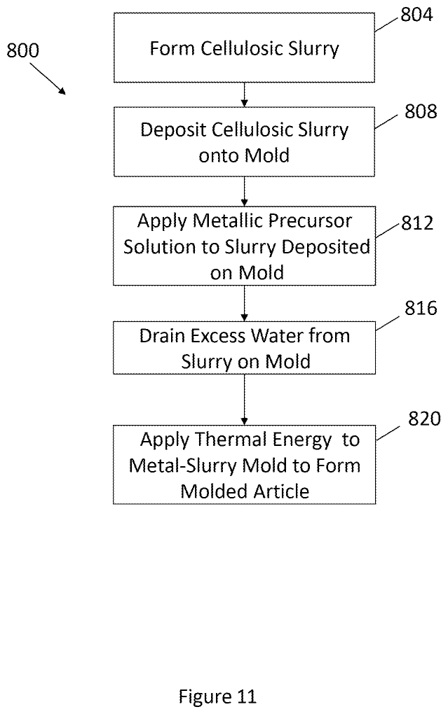

Continuing with FIG. 11, in accordance with an alternative embodiment of the present disclosure, a process 800 is described whereby a cellulosic three-dimensional structure is formed, similar to the process 800 described above. However, in accordance with the alternative embodiment, the process apply the metal precursor solution after the slurry is added to the mold forms. Accordingly, in step 804, a cellulosic slurry is formed. The slurry may be made from cellulosic fibers. The cellulosic fibers may be wood pulp, cotton, rayon, or any other cellulosic material, whether naturally derived or synthetic.

In step 808, the pulp slurry is deposited onto mold having the shape of the desired food packaging article. The mold may include multiple sets of forms to facilitate increased production rates. For instance the pulp slurry may be added to one or more mold forms.

In step 812, a metallic precursor solution is applied to cellulosic slurry, which has been deposited on the mold forms. As described above, the metallic precursor solution may include a metal salt and a reducing agent. In addition, additional agents, such as binders and the like, may added the slurry during step 812. Such agents may include fillers, binders, pigments, sizing agents, wet strength agents, and other common paper making additives. The additional agents may also be added to the solution to adjust certain properties of the resulting substrate. A person of ordinary skill would appreciate what additional agents may be used in addition to the nanoparticle precursors described above. In addition, different techniques may be used to incorporate the metal nanoparticle into the three-dimensional pulp structure. A spray canister may be used to apply the metal pressor solution in step 812. In another example, a curtain coating method may be used to add the nano-metal to the drained slurry on the three-dimensional structure, after step 812. In an alternative embodiment, the metal nanoparticle may be added to the three-dimensional structure prior to step 812.

In step 816, excess water from the pulp-metal slurry deposited on molds is drained via a vacuum or other means.

In step 820, the pulp and moldforms are fed to heating unit (not shown) where enough thermal energy is applied to remove the remnant moisture from the pulp-metal slurry. Drying the pulp-metal slurry with thermal energy removes moisture but also gives rise to formation metal nanoparticles in the molded tray forms by initiating synthesis of the metal nanoparticles on the pulp. More specifically, for example, drying activates a chemical reaction of the metal salt and the reducing agent, thereby reducing the metal salt to the metal nanoparticles in the substrate. One skilled in the art will readily recognize that the time and temperature profile of drying phase will depend upon such varied factors as the basis weight (grammage) of the substrate, the water retained during application of the solution, the composition of the aqueous solutions, and desired maximum temperature reached during the drying phase. Furthermore, application of thermal energy also gives rise to the visible color change in the pulp-metal tray forms from a first color, such as white, to an orange, yellow, red, purple, blue and/or green paper, indicative of various types of metal nanoparticle formed on the surface of the cellulosic pulp structure. In step 820, the pulp-metal slurry may be dried until the moisture content of the slurry is between 5-10%. Following step 820, the molded trays may be released from the molds. The molded trays 400 are then combined with any other needed packaging and a food item.

The recyclability and compost-ability of conventional susceptor packaging is not possible due to the lamination layer, which combine paper and plastic into a single material. This present disclosure, however, directly adds the metallic susceptor to the substrate layer, which enables recyclability. The chemical processes to remove metal particles from paper materials are similar to the regular de-inking process for recycling office waste, magazines, and newsprint. Specifically, the deinking processes makes use of hydrogen peroxide and bleach to remove particles and fillers from post-consumer paper waste. Following metal removal from the paper packaging, the fibers can be re-pulped and reused in recycled paper products.

Embodiments of the present disclosure also include features that may enhance and/or improve food quality. For instance, the metal nanoparticles, such as the silver and/or copper forms, provide a level antimicrobial activity that may inhibit, and in some cases, potentially prevent, microbial growth on food prior to consumption. Accordingly, the microwave susceptor may be considered an antimicrobial microwave susceptor.

In certain embodiments, the susceptors described herein may be configured for metal reclamation. A metal reclamation process also involves a material reuse process, where the metal particles can be dissolved into metallic ions through chemical processing such as acidic washes. Following this process, the metallic ions can be plated onto metal substrates, or can be precipitated out of solution into a metallic salt. Both of which can produce a metallic product that can be re-used to produce future susceptors and/or other products

The following definitions set forth below apply to the present disclosure.

The articles “a” and “an” are used herein to refer to one or to more than one (i.e., to at least one) of the grammatical object of the article. By way of example, “an element” means one element or more than one element.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. Numerical ranges recited herein by endpoints include all numbers and fractions subsumed within that range (e.g., 1 to 5 includes 1, 1.5, 2, 2.75, 3, 3.90, 4, and 5). The upper and lower limits of these smaller ranges may independently be included in the smaller ranges and are encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about”. The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. For example, the term “about” is used herein to modify a numerical value above and below the stated value by a variance of 5%.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in a particular order as desired.

1. A susceptor, comprising:
a) a dimensionally stable substrate layer having a first side and a second side that is opposite the first side; and
b) a metallic layer disposed directly on the first side and composed of a plurality of metal nanoparticles having a size that ranges from 1 to about 200 nanometers in at least one dimension, the metallic layer of a thickness that it absorbs microwave radiation and converts microwave radiation into heat, wherein the metallic layer does not inhibit flow of moisture through the dimensionally stable substrate layer.

2. The susceptor of claim 1, wherein the dimensionally stable substrate layer is a cellulosic layer.

3. The susceptor of claim 2, wherein the cellulosic layer is comprised of two or more layers.

4. The susceptor of claim 1, wherein the thickness of the metallic layer is between about 5 nanometers to 500 microns.

5. The susceptor of claim 1, wherein the metallic layer defines a pattern element.

6. The susceptor of claim 5, wherein the pattern element is a series of parallel lines.

7. The susceptor of claim 5, wherein the pattern element includes one or more alphanumeric characters.

8. The susceptor of claim 5, wherein the pattern element includes one or more two-dimensional shapes that have at least one of a curvilinear component and a linear component.

9. The susceptor of claim 5, wherein the pattern element includes a shape that substantially resembles a regular polygon.

10. The susceptor of claim 5, wherein the pattern element is one or more logos.

11. The susceptor of claim 1, wherein the metal nanoparticles include at least one of: silver, gold, platinum, palladium, aluminum, iron, zinc, copper, cobalt, nickel, manganese, molybdenum, cadmium, iridium, and a mixture thereof.

12. A microwavable food package, comprising:
a microwavable article having an internal space for holding at least one food item; and a susceptor within the internal space of the microwavable article and having a) a dimensionally stable substrate layer having a first side and a second side that is opposite the first side, and b) a metallic layer disposed along the first side and composed of a plurality of metal nanoparticles having a size that ranges from 1 to about 200 nanometers in at least one dimension, the metallic layer of a thickness that it absorbs microwave radiation and converts microwave radiation into heat, wherein the metallic layer does not inhibit flow of moisture through the dimensionally stable substrate layer.

13. The microwavable food package of claim 12, wherein the susceptor is a sleeve.

14. The microwavable food package of claim 12, wherein the dimensionally stable substrate layer is a cellulosic layer.

15. The microwavable food package of claim 14, wherein the cellulosic layer is comprised of two or more layers.

16. The microwavable food package of claim 12, wherein the thickness of the metallic layer is between about 5 nanometers to 500 microns.

17. The microwavable food package of claim 12, wherein the metallic layer defines a pattern element.

18. The microwavable food package of claim 12, wherein the metal nanoparticles include at least one of: silver, gold, platinum, palladium, aluminum, iron, zinc, copper, cobalt, nickel, manganese, molybdenum, cadmium, iridium, and a mixture thereof

19. The microwavable food package of claim 12, wherein the susceptor is fixed to the microwavable article in the internal space and suspended above a bottom to form an upper space and a lower space such that the food item is suspended above the bottom.

20. A microwavable food package article, comprising:
a three-dimensional molded structure having a homogenous mixture a cellulosic pulp and metal nanoparticles disposed directly on or embedded in the cellulosic pulp, the metal nanoparticles having a size that ranges from 1 to about 200 nanometers in at least one dimension, the metal nanoparticles present in the three-dimensional molded structure in an amount sufficient to absorb microwave radiation and converts microwave radiation into heat.

21. The method of claim 20, wherein the metal nanoparticles are between 0.05% up to about 2.0% by weight of the three-dimensional molded structure.

22. The method of claim 20, the three-dimensional molded structure is a molded tray having a bottom, a top, and a sidewall that extends from the bottom to the top.

23. A method of forming a metallized food package, comprising:
forming a slurry including cellulosic fibers;
adding a metal precursor solution to the slurry, the metal precursor solution having one or more metal salts and a reducing agent;
depositing the slurry containing the metal precursor solution onto one or more mold forms;
exposing the slurry containing the metal precursor solution deposited on the one or more mold forms to thermal energy to initiate a reaction of metal ions and slurry, thereby giving rise to metal nanoparticles deposited on or embedded within the cellulosic fibers to form a metallized three-dimensional molded structure; and
removing the metallized three-dimensional molded structure from the one or more mold forms.

24. The method of claim 23, further comprising assembling a housing and three-dimensional molded structure into a food package article.

25. The method of claim 23, wherein the metal nanoparticles have a size that ranges from 1 to about 200 nanometers in at least one dimension.

26. The method of claim 23, wherein the metal nanoparticles are between 0.05% up to about 2.0% by weight of the three-dimensional molded structure.

27. A method of forming a metallized food package, comprising:
forming a slurry including cellulosic fibers;
depositing the slurry onto one or more mold forms;
applying a metal precursor solution to the slurry deposited onto the one or more mold forms;
exposing the metal precursor solution to thermal energy, thereby giving rise to metal nanoparticles deposited on or embedded within the cellulosic fibers to form a metallized three-dimensional molded structure; and
removing the metallized three-dimensional molded structure from the one or more mold forms.

28. The method of claim 27, further comprising assembling a housing and three-dimensional molded structure into a food package article.

29. The method of claim 27, wherein applying the metal precursor solution to the slurry includes spraying the metal precursor solution to the slurry.

30. The method of claim 27, wherein applying the metal precursor solution to the slurry includes curtain coating the metal precursor solution onto the slurry.

31. The method of claim 27, wherein the metal nanoparticles have a size that ranges from 1 to about 200 nanometers in at least one dimension.

32. The method of claim 27, wherein the metal nanoparticles are between 0.05% up to about 2.0% by weight of the three-dimensional molded structure.
